(19) United States
(12) Patent Application Publication
(10) Pub. No.: US 2003/0011473 A1
(43) Pub. Date: Jan. 16, 2003

(54) Apparatus and method for detecting intrusion and non-intrusion events

(75) Inventors: Dusan V. Progovac, Grosse Pointe, MI (US); Michael P. Dotz, Saline, MI (US)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Inc.

(21) Appl. No.: 09/906,173

(22) Filed: Jul. 16, 2001

(51) Int. Cl. G08B 13/18

(52) U.S. Cl. 340/552; 340/425.5; 340/426; 701/45

(57) ABSTRACT

An apparatus (10) and method are provided for detecting an intrusion into a predetermined area. The apparatus (10) includes a transmitter (28) for transmitting a signal within the predetermined area. A first receiver (30) is oriented toward a first location within the predetermined area and receives reflected return signals of the transmitted signal. A second receiver (32) is oriented toward a second location within the predetermined area and receives reflected return signals of the transmitted signal. The second location is different from the first location. A controller (42) determines whether reflected return signals received by the first and the second receivers (30 and 32) indicate an intrusion or a non-intrusion event. The controller (42) provides an alarm signal for an alarm (44) when only one of the reflected return signals received by the first and the second receivers (30 and 32) indicates an intrusion.

### TECHNICAL FIELD

The present invention relates to an intrusion detection apparatus and method. More particularly, the present invention relates to an apparatus that differentiates between an intrusion into a predetermined area and a non-intrusion event and the method by which the apparatus operates.

### BACKGROUND OF THE INVENTION

Several Apparatus types are known for detecting an intrusion into the passenger compartment of a vehicle. In general, if an intrusion is detected, a known apparatus actuates an alarm. The alarm may include sounding the vehicle's horn, flashing the vehicle's lights, and disabling the vehicle's ignition system to render the vehicle inoperative.

One type of a known intrusion detection apparatus utilizes ultrasonic signals and the Doppler principle. For example the apparatus transmits a known frequency signal and monitors the frequency of a reflected signal to detect a change in frequency. A change in the frequency of the reflected signal may be caused by movement within a monitored area and is known as a Doppler shift.

It is possible that a known ultrasonic intrusion detection apparatus may experience a false alarm. Ideally, the apparatus should not detect non-intrusive events that occur within or around the monitored area. Examples of non-intrusive events include an inadvertent striking of the outside of the vehicle, motion near or around the vehicle, air turbulence within the protected area, and temperature changes within the protected area. Nevertheless, these non-intrusive events alter the reflected signal that is monitored by the ultrasonic intrusion detection apparatus. As a result, the non-intrusive event may be interpreted as being an intrusion and may result in a false alarm.

One known intrusion detection apparatus generates a reverberation field within a monitored space. The reverberation field includes a plurality of signals traveling along a plurality of propagation paths within the protected space. The apparatus detects the entry of a new object into the reverberation field or a change in position of an existing object in the reverberation field. An alarm signal is generated when the change in the reverberation field is greater than a predetermined threshold value.

The known intrusion detection apparatus is generally mounted at the center of the ceiling of the passenger compartment of the vehicle. Typically, the ceiling of a vehicle, which is formed by the roof of the vehicle, is formed from flexible sheet metal. As a result, a thump on the body of the vehicle may cause the roof of the vehicle to oscillate and result in oscillation of the known intrusion detection apparatus. Oscillation of the known apparatus may result in the reflected signal caused by the thump on the body of the vehicle being interpreted as an intrusion and may result in a false alarm.

### SUMMARY OF THE INVENTION

In accordance with the present invention, an apparatus and method are provided for detecting an intrusion into a predetermined area.

The apparatus includes a transmitter for transmitting a signal within the predetermined area. A first receiver is oriented toward a first location within the predetermined area. The first receiver receives reflected return signals of the transmitted signal and generates a first output signal indicative of the reflected return signals received. A second receiver is oriented toward a second location within the predetermined area. The second location is different from the first location. The second receiver receives reflected return signals of the transmitted signal and generates a second output signal indicative of the reflected return signals received. A controller receives the first and second output signals. The controller determines whether the first output signal indicates an intrusion or a non-intrusion event. The controller also determines whether the second output signal indicates an intrusion or a non-intrusion event. The controller provides an alarm signal when only one of the first and second output signals indicates an intrusion.

The method of the present invention includes the following steps for detecting an intrusion into a predetermined area: (i) orienting a first receiver toward a first location within the predetermined area; (ii) orienting a second receiver toward a second location within the predetermined area, the second location being different from the first location; (iii) transmitting a signal within the predetermined area; (iv) receiving reflected return signals of the transmitted signal at the first receiver; (v) receiving reflected return signals of the transmitted signal at the second receiver; (vi) determining whether the reflected return signals received at the first receiver indicate an intrusion or a non-intrusion event; (vii) determining whether the reflected return signals received at the second receiver indicate an intrusion or a non-intrusion event; and (viii) providing an alarm signal if the reflected return signals at only one of the first and second receivers indicate an intrusion.

### BRIEF DESCRIPTION OF THE DRAWINGS

Further features and advantages of the present invention will become apparent to those skilled in the art from reading the following description with reference to the accompanying drawings, in which:

FIG. 1 is a schematic diagram of an apparatus, in accordance with the present invention, mounted on a vehicle ceiling;

FIG. 2 is a schematic block diagram of the apparatus of FIG. 1;

FIG. 3 is a schematic block diagram of the first envelope detecting circuit shown in FIG. 2;

FIG. 4 illustrates a non-intrusion reflected return signal and the resultant waveform envelope;

FIG. 5 illustrates an intrusion reflected return signal and the resultant waveform envelope;

FIG. 6 is a flowchart diagram showing a control process in accordance with the present invention;

FIGS. 7A and 7B are flowchart diagrams of the control process in accordance with the present invention during a first time window; and

FIG. 8 is flowchart diagram of the control process in accordance with the present invention during a second time window.

### DESCRIPTION OF AN EXAMPLE EMBODIMENT

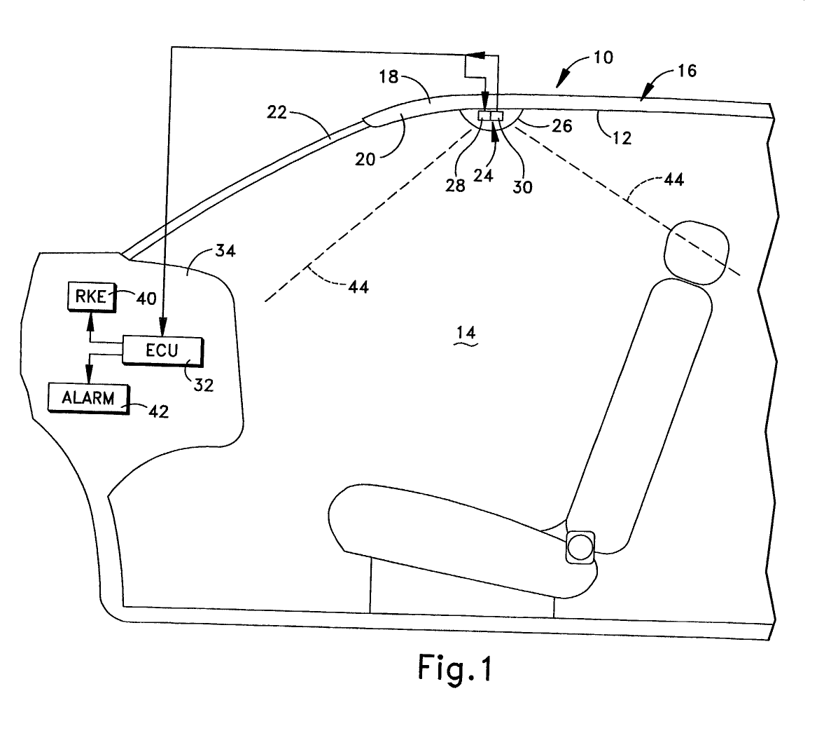

FIG. 1 illustrates schematically an intrusion detection apparatus 10, in accordance with the present invention, mounted to the ceiling 12 of the passenger compartment 14 of a vehicle 16. The ceiling 12 is formed by the interior of the roof 18. Alternatively, the apparatus 10 may be mounted at some other location within the vehicle passenger compartment 14, such as on a headliner 20, between front seats of the vehicle 16, or on a central portion of an upper edge of a front windshield 22. A suitable location is one that allows a signal that is transmitted by the apparatus 10 to cover a significant portion of the passenger compartment 14 of the vehicle 16.

The apparatus 10 includes a transceiver 24 that is mounted in an overhead console 26. Preferably, the transceiver 24 is an ultrasonic device that transmits and receives ultrasonic signals. As an alternative to an ultrasonic transceiver, an infrared transceiver may be used. The transceiver 24 includes a transmitter 28 and multiple receivers, two of which are shown in FIG. 1 and indicated at 30 and 32.

The transmitter 28 transmits signals into the passenger compartment 14 of the vehicle 16. Preferably, the transmitted signals are continuous wave, ultrasonic signals. Objects within the passenger compartment 14 reflect the signals throughout the passenger compartment 14 of the vehicle 16. A first receiver 30 is oriented toward a first portion (not shown) of the passenger compartment 14 of the vehicle 16 and receives reflected signals, most of which reflect off of objects in the first portion of the passenger compartment 14. A second receiver 32 is oriented toward a second portion (not shown) of the passenger compartment 14 of the vehicle 16 and receives reflected signals, most of which reflect off of objects in the second portion of the passenger compartment 14. Preferably, the first portion of the passenger compartment 14 of the vehicle 16 is an area near the driver side window (not shown) of the vehicle 16 and the second portion of the passenger compartment 14 of the vehicle 16 is an area near the passenger side window (not shown) of the vehicle 16. The reflected signals received by the first and second receivers 30 and 32 may include changes in frequency, amplitude, and phase, each of which is dependent upon motion of an object within the passenger compartment 14 of the vehicle 16.

The operating frequency of the transmitter 28 is predetermined. In an exemplary embodiment, the transmitter 28 is a NICERA piezo transducer AT/R40-10 with operating frequency at 40 kHz. The operating frequency of the transmitter 28 is preferably greater than the human listening range (i.e., greater than 20 kHz).

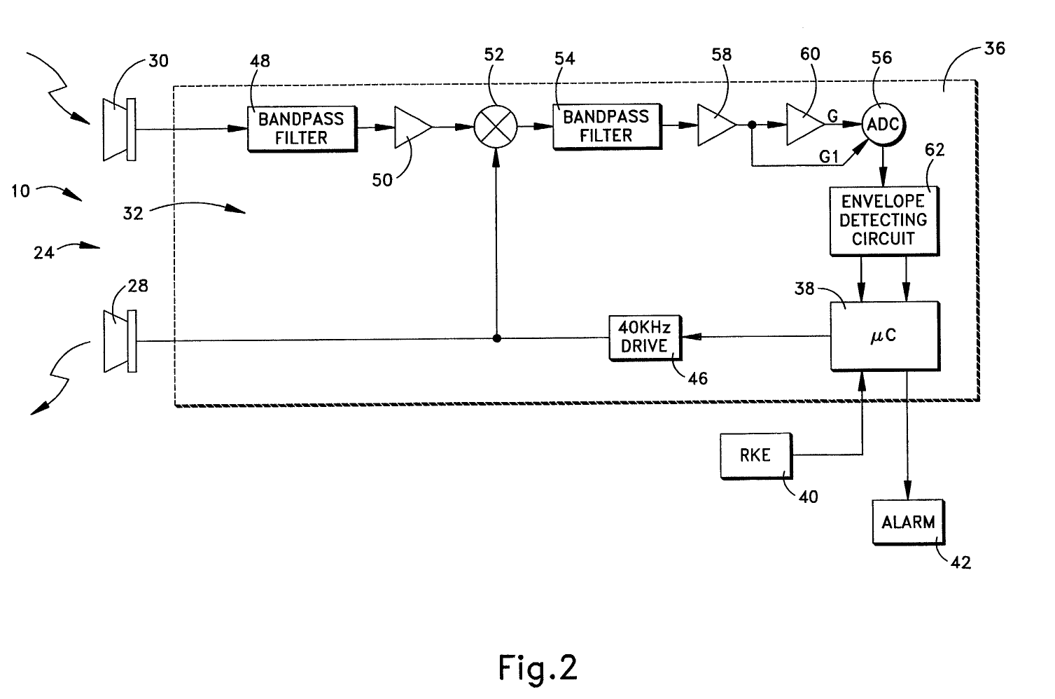

An electronic control unit 34 (“ECU”) is operatively connected to the transceiver 24. The ECU 34 is preferably located within the vehicle's instrument panel 36. Preferably, the ECU 34 includes multiple process circuits 38 and 40 (FIG. 2), one for each receiver 30 and 32, and a controller 42. FIG. 2 shows a first process circuit 38 connected to the first receiver 30 and a second process circuit 40 connected to the second receiver 32. Each process circuit 38 and 40 includes a plurality of discrete circuits and circuit components. The ECU 34 controls the transceiver 24 and, after receipt of the reflected signals from the receivers 30 and 32, discriminates between an intrusion into the passenger compartment 14 and a non-intrusion event.

The controller 42 includes a switching element (not shown) that is actuatable to enable and disable the apparatus 10. One method of actuating the switching element is by a remote keyless entry (“RKE”) system (not shown). The RKE system allows the vehicle operator to disable the apparatus 10 before entering the vehicle 16 and to enable the apparatus 10 upon exiting the vehicle 16.

The ECU 34 is operatively connected to and controls an alarm 44 (FIG. 1). As will be discussed in detail below, upon detection of an intrusion into the passenger compartment 14 of the vehicle 16, the controller 42 provides an alarm signal that actuates the alarm 44. The alarm 44 may include the sounding of the vehicle's horn, flashing of the vehicle's lights, and disabling of the vehicle's ignition system. Of course, it is to be appreciated that the alarm may provide for any other suitable function (e.g., remote notification, etc.) that is associated with intrusion detection.

When the apparatus 10 is enabled, the transceiver 24 transmits and receives ultrasonic signals. Preferably, the transmitter 28 of the transceiver 24 transmits continuous wave (“CW”) signals as beams, indicated at 46 in FIG. 1. The beams 46 are transmitted throughout the passenger compartment 14 of the vehicle 16, each being directed toward a particular portion of the passenger compartment 14. The ultrasonic signals reflect off of objects in the passenger compartment 14 of the vehicle 16 and travel throughout the passenger compartment 14. Portions of the reflected signals return to the receivers 30 and 32. As a result, each of the receivers 30 and 32 receives a single wave return signal that is a superposition of all the reflected signals received by the particular receiver 30 or 32. Generally, the return signal received by each receiver 30 or 32 has the same frequency as the transmitted signal, but has a phase and amplitude that varies from the transmitted signal. The phase and amplitude of the return signal are dependent upon the phase and amplitude of the various reflected signals added together at the receiver 30 or 32 to form the return signal.

The frequency, amplitude, and phase of the return signal received by each receiver 30 or 32 is expected to remain constant over time if there is no motion within the passenger compartment 14 and the temperature within the passenger compartment 14 remains constant. However, motion in the passenger compartment 14 or a change in temperature within the passenger compartment 14 alters the reflected signals and, thus, the return signal received at each receiver 30 and 32. Motion within the passenger compartment 14 of the vehicle 16 results in a Doppler shift in the frequency of the signals reflected off of the object in motion. A Doppler shift in the frequency of some of the reflected signals alters the frequency, amplitude, and phase of the return signal received by each receiver 30 or 32. Although the motion of the object in the passenger compartment 14 will alter the return signal received by each receiver 30 or 32, the return signal received by the particular receiver 30 or 32 that monitors the portion of the vehicle in which the motion occurs will be affected to a greater extent than the return signal of the other receiver 30 or 32 that monitors another portion of the vehicle 16. For example, if the motion occurs near the driver side window of the vehicle 16, the return signal received by the first receiver 30 will be affected to a greater extent than the return signal received by the second receiver 32.

During operation of the apparatus 10, the CW signals transmitted from the transmitter 28 reflect off of objects, stationary or moving (i.e., an intruder), within the passenger compartment 14 of the vehicle 16. As described above, each receiver 30 and 32 receives a portion of the reflected signals. Upon receipt of the reflected signals, each receiver 30 or 32 outputs an output signal to the ECU 34. The ECU 34 processes the output signal from each receiver 30 and 32 to determine a waveform envelope of the respective output signal. The ECU 34 then determines whether the respective waveform envelope is indicative of an intrusion into the passenger compartment 14 or a non-intrusion event.

As will be described in greater detail below, the controller 42 of the ECU 34 includes an exclusive-OR gate (not shown). Upon determining whether a first waveform envelope from a first output signal received from the first receiver 30 is indicative of an intrusion or a non-intrusion event, a first value is input into the exclusive-OR gate. Upon determining whether a second waveform envelope from a second output signal received from the second receiver 32 is indicative of an intrusion or a non-intrusion event, a second value is input into the exclusive-OR gate. If only one of the output signals from the first and second receivers 30 and 32 indicates an intrusion into the passenger compartment 14 of the vehicle 16, the alarm 44 is actuated. If both of the output signals from the first and second receivers 30 and 32 indicate an intrusion, or both indicate a non-intrusion event, then the alarm 44 is not actuated and a non-intrusion event is presumed.

The use of the exclusive-OR gate helps to prevent false alarms while consistently detecting an intrusion into the vehicle 16. For example, if the temperature within the passenger compartment 14 of the vehicle 16 increases, the output signals from both the first and second receivers 30 and 32 may indicate an intrusion. The exclusive-OR gate will prevent actuation of the alarm 44 in this case. However, if an intruder attempts to enter the passenger compartment 14 of the vehicle 16 through the driver side window, the first output signal will indicate an intrusion and the second output signal will indicate a non-intrusion event. The first output signal will indicate an intrusion since motion near the driver side window significantly alters the return signal received by the first receiver 30. The second output signal will indicate a non-intrusion event since there is no motion near the passenger side window that is being monitored by the second receiver 32.

FIG. 2 is a functional block diagram illustrating the ECU 34. The ECU 34 includes the first process circuit 38, the second process circuit 40, and the controller 42. As shown, the first process circuit 38 includes a first envelope detecting circuit 48 and the second process circuit 38 includes a second envelope detecting circuit 50.

An oscillating drive circuit 52 generates a CW signal that is applied to the transmitter 28 of the transceiver 24. This CW signal can be either a square wave or a sinusoidal waveform. Preferably, the oscillating drive circuit 52 generates a 40 kHz signal that drives the transmitter 28 and results in the transmitter 28 transmitting a continuous wave ultrasonic signal at 40 kHz into the passenger compartment 14 of the vehicle 16. As shown in FIG. 2, both the first and second process circuits 38 and 40 share one oscillating drive circuit 52.

The ultrasonic wave signals transmitted by the transmitter 28 reflect off of objects within the passenger compartment 14 of the vehicle 16. As a result, a reverberation field is established within the passenger compartment 14 of the vehicle 16. As stated above, the first receiver 30 generally receives reflected signals from near the driver side window of the vehicle and the second receiver 32 generally receives reflected signals from near the passenger side window of the vehicle 16. As a result, the first output signal from the first receiver 30 is indicative of conditions near the driver side window and the second output signal from the second receiver 32 is indicative of conditions near the passenger side window.

The first output signal passes from the first receiver 30 into the first process circuit 38. The first output signal is input into a bandpass filter 54. The bandpass filter 54 eliminates noise not associated with the intrusion effects to be detected by the apparatus 10 and prevents the first output signal from overloading a pre-amplifier 56. The bandpass filter 54 passes the filtered first output signal to the pre-amplifier 56. The pre-amplifier 56 amplifies the first output signal and passes the first output signal to a synchronous demodulator 58. The output of the oscillating drive circuit 52 is also connected to the synchronous demodulator 58.

The demodulator 58 synchronously demodulates the first output signal with the CW drive signal from the oscillating drive circuit 52. The CW drive signal from the oscillating drive circuit 52 is used as the demodulation reference. The demodulator 58 extracts frequency and amplitude components of the first output signal that would indicate motion of an object near the driver side window in the passenger compartment 14 of the vehicle 16.

The demodulated first output signal passes to a second bandpass filter 60. The second bandpass filter 60 removes the DC background from the demodulated first output signal. The DC background is associated with temperature changes and air circulation within the passage compartment 14 of the vehicle 16. The lower limit of the second bandpass filter 60 may be below 1 Hz and the upper limit is selected to be greater than the expected frequency that would result during an intrusion. The upper limit should be low enough, however, to provide some noise rejection and anti-aliasing of an analog-to-digital converter 62 (“ADC”) used to further process the first output signal.

The first output signal passes from the second bandpass filter 60 to a post-amplifier 64, which further amplifies the first output signal. The first output signal then passes into the ADC 62. Preferably, the ADC 62 has a sample rate of 1 kHz. The 1 kHz sample rate results in the upper limit of the second bandpass filter 60 being at or below 500 Hz.

The ADC 62 passes the digitized value of the first output signal to the first envelope detecting circuit 48. The first envelope detecting circuit 48 could be implemented in digital form as an algorithm running on the controller 42. The first envelope detecting circuit 48 determines a first waveform envelope of the first output signal.

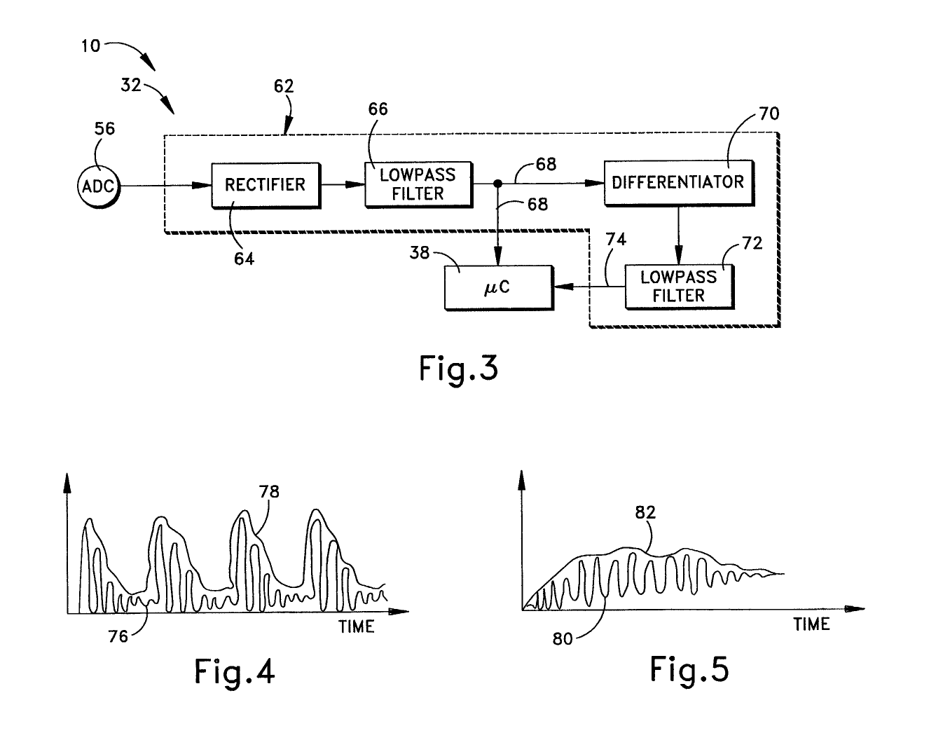

FIG. 3 illustrates an example embodiment of the first envelope detecting circuit 48. The first envelope detecting circuit 48 includes a rectifier signal processing means 66 for digitally rectifying the demodulated first output signal. The first envelope detecting circuit 48 also includes a low-pass filter 68. One type of low-pass filter 68 that may be used is a recursive filter that achieves a long impulse response without having to perform a long convolution. The recursive filter removes noise jitters or spikes from the rectified first output signal.

The rectified first output signal, after being filtered by the low-pass filter 68 is indicated in FIG. 3 at 70. The first output signal 70 is then input into both the controller 42 and a combination of a differentiator 72 and a low-pass filter 74. The combination of the differentiator 72 and the low-pass filter 74 generates a filtered derivative value 75 of the first output signal. The filtered derivative value 75 of the first output signal is also input into the controller 42.

With reference to FIG. 2, the second output signal passes from the second receiver 32 into the second process circuit 40. The second output signal is input into a bandpass filter 76. The bandpass filter 76 eliminates noise not associated with the intrusion effects to be detected by the apparatus 10 and prevents the second output signal from overloading a preamplifier 78. The bandpass filter 76 passes the filtered second output signal to the pre-amplifier 78. The pre-amplifier 78 amplifies the second output signal and passes the second output signal to a synchronous demodulator 80. The output of the oscillating drive circuit 52 is also connected to the synchronous demodulator 80.

The demodulator 80 synchronously demodulates the second output signal with the CW drive signal from the oscillating drive circuit 52. The CW drive signal from the oscillating drive circuit 52 is used as the demodulation reference. The demodulator 80 extracts frequency and amplitude components of the second output signal that would indicate motion of an object near the passenger side window in the passenger compartment 14 of the vehicle 16.

The demodulated second output signal passes to a second bandpass filter 82. The second bandpass filter 82 removes the DC background from the demodulated second output signal. The lower limit of the second bandpass filter 82 may be below 1 Hz and the upper limit is selected to be greater than the expected frequency that would result during an intrusion. The upper limit should be low enough, however, to provide some noise rejection and anti-aliasing of an analog-to-digital converter 84 (“ADC”) used to further process the second output signal.

The second output signal passes from the second bandpass filter 82 to a post-amplifier 86, which further amplifies the second output signal. The second output signal then passes into the ADC 84. Preferably, the ADC 84 has a sample rate of 1 kHz. The 1 kHz sample rate results in the upper limit of the second bandpass filter 82 being at or below 500 Hz.

The ADC 84 passes the digitized second output signal to the second envelope detecting circuit 50. The second envelope detecting circuit 50 could be implemented in digital form as an algorithm running on the controller 42. The second envelope detecting circuit 50 determines a second waveform envelope of the second output signal. The second envelope detecting circuit 50 is not shown in detail but has a configuration similar to that of the first envelope detecting circuit 48 illustrated in FIG. 3. The second envelope detecting circuit 50 outputs a second output signal and a filtered derivative value of the second output signal to the controller 42.

FIG. 4 illustrates a time representation a return signal 88 for a non-intrusive event, e.g., four thumps on the outside of a vehicle window. The waveform envelope 90 for the non-intrusive event is also shown. The waveform envelope 90 is a harmonic signal with a rapid rise time followed by a slower, but also rapid, decay time. Normally, a non-intrusion event does not occur regularly so as to generate a continuous waveform envelope such as that illustrated in FIG. 4. Typically, the non-intrusion event forms a plurality of spaced waveform envelopes. When a non-intrusion event occurs, the time between the rise of the waveform envelope 90 above a threshold level and the decay of the waveform envelope 90 below the threshold level is less than 250 milliseconds.

FIG. 5 illustrates a time representation of a return signal 92 for an intrusion. The waveform envelope 94 for the intrusion is also shown. The waveform envelope 94 is a harmonic signal with a slow rise time. As long as motion continues during the intrusion, the waveform envelope 94 is continuous with an amplitude greater than the threshold level. Thus, the waveform envelope 94 for an intrusion has an amplitude above the threshold level for a time period of greater than 250 milliseconds.

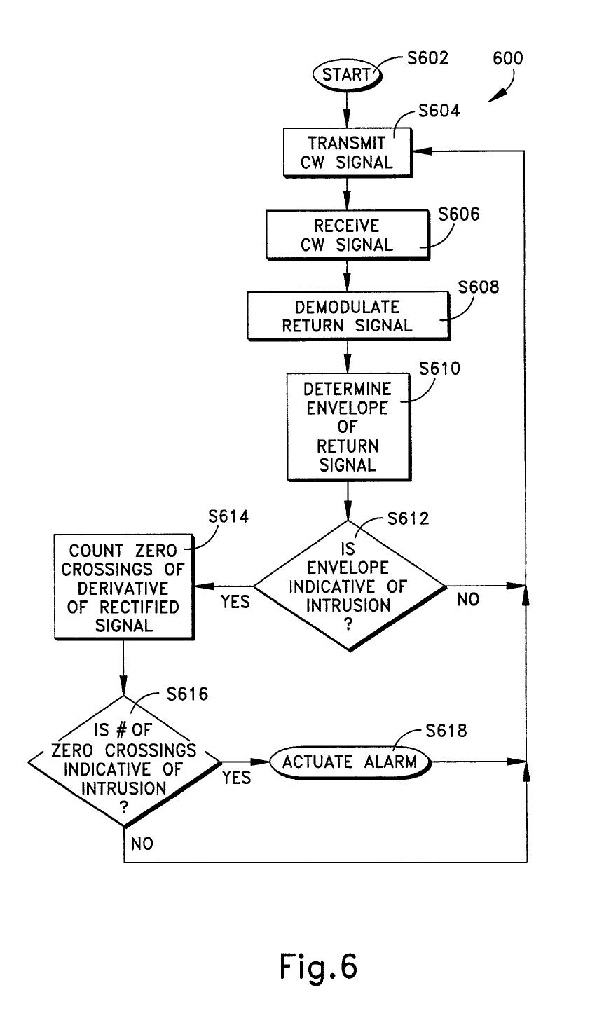

FIG. 6 illustrates a control process 600, in accordance with the present invention, for determining the existence of an intrusion or a non-intrusion event into the passenger compartment 14 of the vehicle 16. The process 600 begins at step S602 where memories are cleared, initial flag conditions are set, etc., in a manner known in the art. The process 600 then proceeds to step S604 where the transmitter transmits a continuous wave signal within a predetermined area, i.e., the passenger compartment 14 of the vehicle 16. From step S604, the process 600 proceeds to steps S606 and S614. At step S606, the first receiver 30 receives the reflected return signals. The process 600 next proceeds to step S608. At step S608, the first output signal from the first receiver 30 is demodulated. In step S610, the first waveform envelope of the demodulated first output signal is determined. From step S610, the process 600 proceeds to step S612. At step S612, a determination is made as to whether the first waveform envelope is indicative of an intrusion or a non-intrusion event. The process 600 next proceeds to step S622.

At step S614, the second receiver 32 receives the reflected return signals. The process 600 next proceeds to step S616. At step S616, the second output signal from the second receiver 32 is demodulated. In step S618, the second waveform envelope of the demodulated second output signal is determined. From step S618, the process 600 proceeds to step S620. At step S620, a determination is made as to whether the second waveform envelope is indicative of an intrusion or a non-intrusion event. The process 600 next proceeds to step S622.

At step S622, a determination is made as to whether only one of the first and second waveform envelopes indicates an intrusion. If only one of the first and second waveform envelopes indicates an intrusion, then the process 600 proceeds to step S624, and the alarm 44 is actuated. The process 600 then returns to step S602. If neither of the first and second envelope signals indicates an intrusion, the process 600 returns to step S602. If both of the first and second envelope signals indicate an intrusion or a non-intrusion event, then the process 600 returns to step S602.

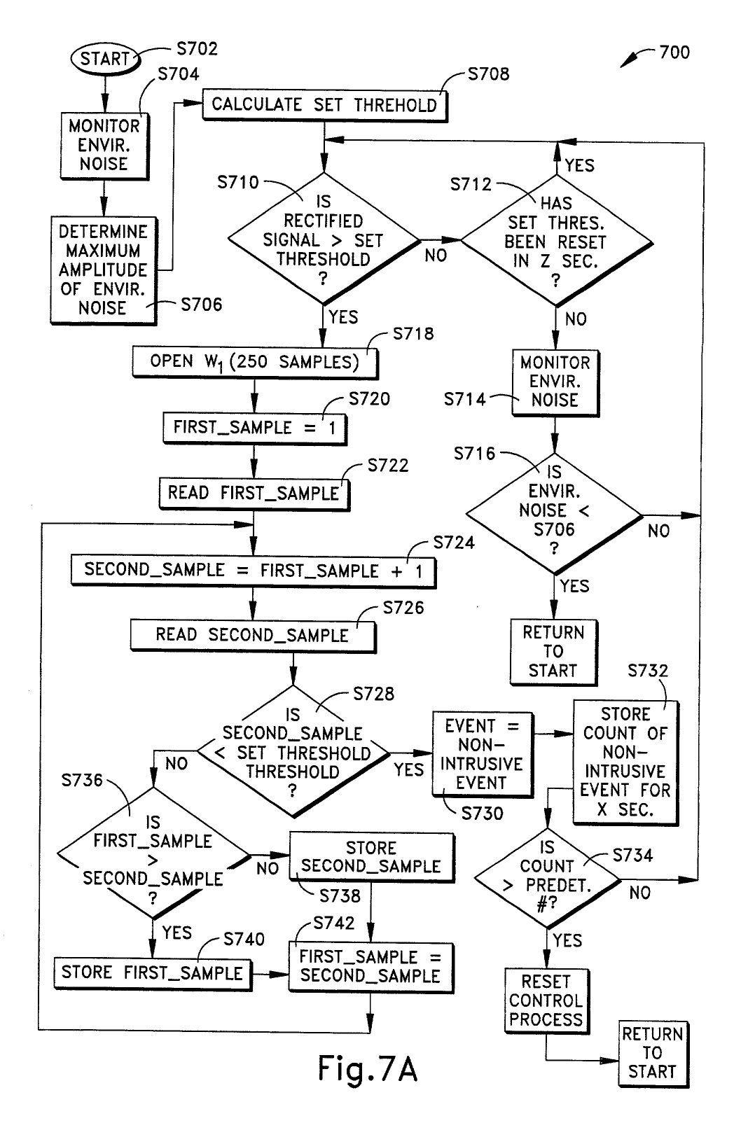

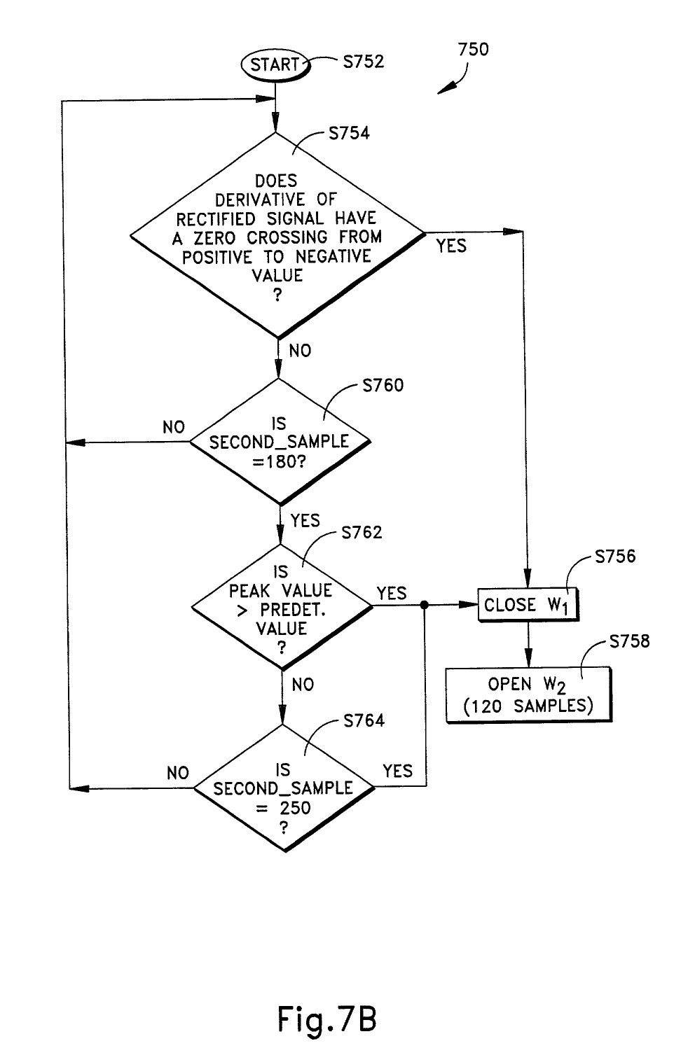

FIG. 7A illustrates a control process 700 that is performed by the controller 42 to accomplish the steps indicated at steps S612 and S620 in FIG. 6. This control process 700 monitors a respective waveform envelope by dividing the respective waveform envelope into time windows. Each time window includes a predetermined number of time sampled values. Each of the time sampled values is indicative of the amplitude of the respective waveform envelope at the time the sample value is taken. The amplitude of the respective waveform envelope at a particular point in time is the value of the rectified return signal at that point in time. The time sampled values are analyzed and compared against predetermined thresholds.

Since the waveform envelope of a non-intrusion event has a rapid rise time compared to a signal from an intrusion, the first time window is used to determine the presence of a false alarm or a nonintrusion event. As will be discussed below, an intrusion is not determined, in accordance with the present invention, until after a second time window is opened.

From empirical data, it has been determined that a waveform envelope of a non-intrusion event takes between 100 to 200 milliseconds to reach a peak value and between 100 to 150 milliseconds to decay below the threshold level. It has also been determined that a waveform envelope of an intrusion is sustained above the threshold level for over 300 milliseconds. As a result, for illustrative purposes, the first time window equals 180 milliseconds and the second time window equals 120 milliseconds.

The control process 700 of FIG. 7A begins at step S702 where internal memories of the controller 42 are reset, flags are set to initial conditions, etc. in a manner well known in the art. At step S704, a set threshold is calculated. The set threshold is computed by calculating the running average of the rectified output signal 70 (FIG. 3) and adding to the running average a RMS (“root-mean-square”) value of the rectified output signal 70 multiplied times four. The duration of the running average and the multiplier for the RMS value vary from application to application and are determined through empirical testing and analysis for each vehicle platform of interest.

At step S706, the value of the rectified output signal 70 is repeatedly evaluated at a predetermined rate. The values are sequentially processed. The value of the rectified output signal 70 is compared against the calculated set threshold from step S704 and a determination is made as to whether the value of the rectified output signal 70 exceeds the set threshold from step S704. If the value of the rectified output signal 70 exceeds the set threshold and if the low-pass filtered derivative signal 75 (FIG. 3) exceeds a predetermined positive threshold, the process 700 proceeds to step S708. If the determination is negative, the process loops back onto itself until an affirmative determination occurs.

At step S708, a first time window W₁ is opened (i.e., a first time period begins to run). In accordance with the preferred embodiment, the first time window W₁ is open for a time sufficient to permit a maximum of 180 samples of the rectified output signal 70. From step S708, the process 700 proceeds to step S710.

At step S710, a FIRST_SAMPLE pointer is initialized to equal a time position for the first sample of the rectified output signal during the first time window W₁. From step S710, the process 700 proceeds to step S712. At step S712, the process 700 reads a FIRST_SAMPLE, X_{FIRST}_{_{—}}_{SAMPLE} of the rectified output signal 70. At step S714, a SECOND_SAMPLE pointer is initialized to equal the time position for the second sample of the rectified return signal 70 during the first time window W₁. In a preferred embodiment, what is referred to as the SECOND_SAMPLE pointer value ranges from 2 to 180, i.e., the first time window W₁ is divided into 180 time positions. At step S716, the process 700 reads a second sample, X_{SECOND}_{_{—}}_{SAMPLE}, of the rectified output signal 70 at the next pointer (time position). From step S716, the process 700 proceeds to step S718.

At step S718, a determination is made as to whether the second sample read is less than the calculated set threshold (step S704). If the determination is affirmative, the process 700 proceeds to step S720 where the EVENT status is determined to be a non-intrusive event. The process 700 then proceeds to step S722. At step S722, the control process 700 resets, i.e., the subroutine process ends and returns to step S702. A new set threshold is calculated, and the process 700 proceeds as described above. If the determination is negative, from step S718, the process 700 proceeds to step S724.

At step S724, a determination is made as to whether the value of the FIRST_SAMPLE is greater than the value of the SECOND_SAMPLE. If X_{FIRST}_{_{—}}_{SAMPLE} is less than or equal to X_{SECOND}_{_{—}}_{SAMPLE}, the process 700 proceeds to step S726. When the value of the SECOND_SAMPLE is greater than the value of the FIRST_SAMPLE, the rectified output signal 70 is increasing. At step S726, the X_{SECOND}_{_{—}}_{SAMPLE} value is stored. If the value of the FIRST_SAMPLE is greater than the value of the SECOND_SAMPLE, meaning that the rectified output signal is decreasing in value, the process 700 proceeds to step S728. At step S728, the process 700 stores X_{FIRST}_{_{—}}_{SAMPLE} value. From step S726 or step S728, the process 700 proceeds to step S730.

At step S730, the SECOND_SAMPLE now becomes the FIRST_SAMPLE and the process 700 loops back to step S714. At step S714, the position pointer of the SECOND_SAMPLE is moved to the next pointer position (time location) in the first time window W₁. At step S716, the process 700 reads a new SECOND_SAMPLE value, X_{SECOND}_{_{—}}_{SAMPLE}, which is equal to the previous SECOND_SAMPLE value plus one. As a result, the process 700 successively compares, throughout the 180 samples of the first time window W₁, the value of one sample point within the first time window W₁ with the value of a subsequent sample point within the first time window W₁. The process 700 also monitors and stores the largest sample value of the two sample values compared.

Once the process 700 stores either a first or second sample value, at step S726 or S728, the process 700 then starts the subroutine control process 750 that is illustrated in FIG. 7B. The subroutine control process 750 is used to determine whether the first time window W₁ should be closed and a second time window W₂ opened.

Process 750 of FIG. 7B is initiated at step S752 and proceeds to step S754. At step S754, a determination is made as to whether the derivative of the rectified output signal 75 (FIG. 3) has a zero crossing from positive to negative. If the derivative of the rectified output signal 75 does not have a zero crossing, the process 750 proceeds to step S756. At step S756, if the total number of samples within the first time window W₁ does not equal the maximum number of time samples within the first time window W₁ (i.e., 180), process returns to step S754.

If the determination in step S754 is affirmative, i.e., the derivative of the rectified output signal 75 does have a zero crossing or, the determination in step S756 is affirmative, i.e., the maximum number of samples within the first window W₁ equals 180, then the process 750 proceeds to step S758. At step S758, the first time window W₁ is closed and, at step S760, the second time window W₂ is opened.

In a preferred embodiment, the time period of the second time window W₂ is equal to 120 milliseconds. It should be appreciated that the first time window W₁ is open for 180 time samples or until the determination in step S752 is affirmative.

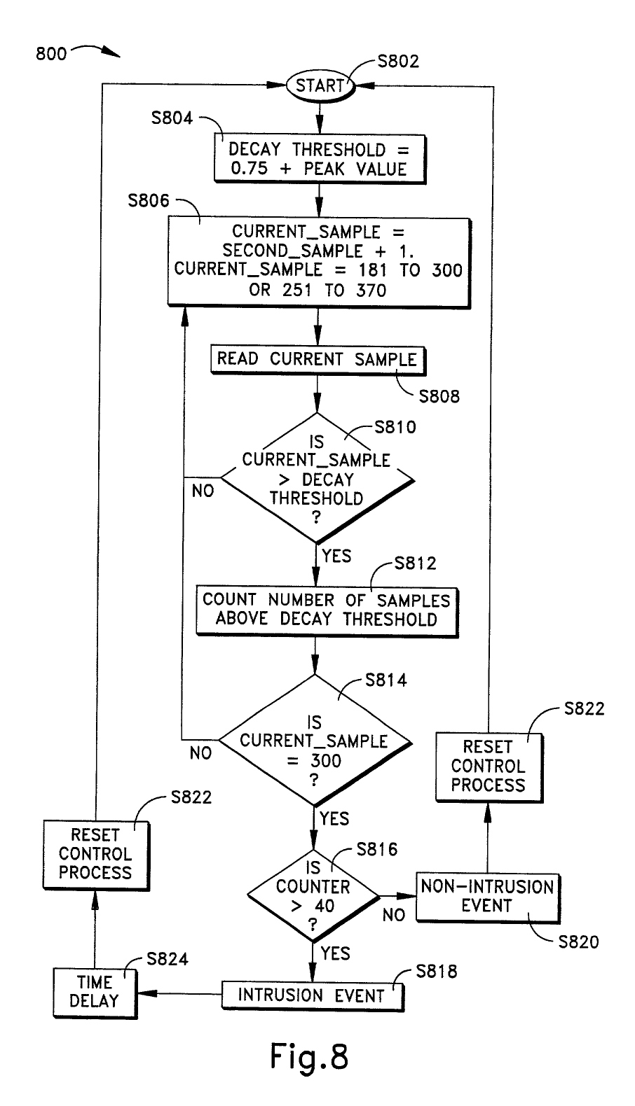

The algorithm implemented to evaluate the second time window W₂ is shown in FIG. 8. The process 800 is initiated at step S802 and proceeds to step S804. At step S804, a decay threshold is calculated. Preferably, the decay threshold is equal to 0.75 times the maximum peak value monitored and stored during the first window W₁. From step S804, process 800 proceeds to step S806. A current sample value is a value of the rectified output signal 70 at a point in time when the second time window W₂ opens. As a result, at step S806 the current sample indicator is set to equal to the point in time where the first time window W₁ closes and increments that point by one. Thus, if the first time window W₁ stayed open for the full 180 time samples, the pointer would then be at 181. However, if the first time window W₁ closed before reaching a pointer value of 180, the pointer value would be equal to the last pointer value plus 1. From step S806, the process 800 proceeds to step S808.

At step S808, the first sample within the second time window W₂ is read, i.e., the rectified output signal value 70 is measured. From step S808, the process 800 proceeds to step S810 where a determination is made as to whether the first sample within the second time window W₂, now the current sample, is greater than the decay threshold value. If the determination is negative and the current sample is not greater than the decay threshold value, the process 800 returns to step S806. If the determination is affirmative, i.e., the current sample is greater than the decay threshold value, the process 800 proceeds to step S812. At step S812, the number of samples of the rectified output signal 70 in the second time window W₂ that are above the decay threshold value are counted. From step S812, the process 800 proceeds to step S814.

At step S814, a determination is made as to whether the current sample is at 300. If the determination at step S814 is negative, the process 800 returns to step S806. If the determination at step S814 is affirmative, the process 800 goes to step S816.

At step S816, a determination is made as to whether the number of samples within the second time window W₂ above the decay threshold value (the count of step S812) exceeds a predetermined number. For illustrative purposes, the preset number is equal to 40 samples. If the number of samples within the second time window W₂ exceeds 40 samples, then the process 800 proceeds to step S818 where an intrusion event flag is set. If the number of samples within the second time window W₂ does not exceed 40 samples, the process 800 proceeds to step S820 where a non-intrusion event flag is set.

Thus, during the first time window W₁ the maximum value, or peak, of the waveform envelope formed by the rectified output signal 70 is determined. During the second window, the width of the waveform envelope that is above the decay threshold value is determined. The determination of an intrusion is dependent upon the width of the waveform envelope above the decay threshold value.

After the determination of an intrusion or a non-intrusion event, step S818 or S820, the process 800 is reset. If a non-intrusion event is determined, the process 800 proceeds to step S822 and is reset immediately by returning to step S702 of FIG. 7A. If an intrusion event is determined, the process 800 proceeds to step S824, where a time delay occurs. From step S824, the process 800 goes to step S822 where the control process is reset by returning to step S702 of FIG. 7A.

With reference to FIG. 6, the control processes illustrated in FIGS. 7A, 7B, and 8 are performed on both the first output signal from the first receiver 30 and the second output signal from the second receiver 32. The determination of an intrusion or non-intrusion event from both the first output signal and the second output signal is input into the exclusive-OR gate of the controller 42. As set forth at step S622, if only one of the first and second output signals indicates an intrusion, the alarm 44 is actuated (step S624). If both of the first and second output signals indicate an intrusion, the alarm 44 is not actuated and the process 600 is reset. If both the first and the second output signals indicate a non-intrusion event, the alarm 44 is not actuated and the process 600 is reset.

Although the foregoing description has specifically applied the apparatus 10 of the present invention to detecting an intrusion into the passenger compartment 14 of a vehicle 16, the apparatus 10 may be used to detect an intrusion into any predefined area. The apparatus 10 of the present invention, by monitoring multiple receivers and using the exclusive-OR gate to determine when to actuate the alarm 44, helps to prevent false alarms while consistently detecting an intrusion.

From the above description of the invention, those skilled in the art will perceive improvements, changes and modifications. Such improvements, changes and modifications within the skill of the art are intended to be covered by the appended claims.

Having described the invention, we claim the following:

1. An apparatus for detecting an intrusion into a predetermined area, the apparatus including:
a transmitter transmitting a signal within the predetermined area;
a first receiver oriented toward a first location within the predetermined area, the first receiver receiving reflected return signals of the transmitted signal and generating a first output signal indicative of the reflected return signals received;
a second receiver oriented toward a second location within the predetermined area, the second location being different from the first location, the second receiver receiving reflected return signals of the transmitted signal and generating a second output signal indicative of the reflected return signals received;
a controller for receiving the first and second output signals, the controller determining whether the first output signal indicates an intrusion or a non-intrusion event, the controller also determining whether the second output signal indicates an intrusion or a non-intrusion event, the controller providing an alarm signal when only one of the first and second output signals indicates an intrusion.

2. The apparatus as defined in claim 1 further including first and second process circuits, the first process circuit processing the first output signal and forming a first waveform envelope and the second process circuit processing the second output signal and forming a second waveform envelope.

3. The apparatus as defined in claim 2 wherein the first process circuit includes a first demodulator for demodulating the first output signal and a first envelope detecting signal processing means for determining the first waveform envelope of the first output signal; and
the second process circuit including a second demodulator for demodulating the second output signal and a second envelope detecting signal processing means for determining the second waveform envelope of the second output signal.

4. The apparatus as defined in claim 3 wherein the controller includes first and second monitors, the first monitor monitoring the first output signal during time windows and the second monitor monitoring the second output signal during the time windows.

5. The apparatus as defined in claim 4 wherein the controller further includes first and second discriminators for discriminating between an intrusion and a non-intrusion event, the first discriminator receiving the first output signal and the second discriminator receiving the second output signal, each of the first and second discriminators including:
(a) first determining means for determining a non-intrusion event when a value of the respective waveform envelope during a first predetermined time window is less than a first predetermined threshold,
(b) second determining means for determining an intrusion event when a predetermined number of samples of the respective waveform envelope during a second predetermined time window is greater than a second predetermined threshold, and
(c) third determining means for determining a non-intrusion event when the predetermined number of samples of the respective waveform envelope during the second predetermined time window is less than the second predetermined threshold.

6. The apparatus as in claim 5 wherein the first discriminator outputs a first discriminator signal indicating a determination of an intrusion or of a non-intrusion event and wherein the second discriminator outputs a second discriminator signal indicating a determination of an intrusion or of a non-intrusion event.

7. The apparatus as in claim 6 wherein the controller further includes an exclusive-OR gate, the first and second discriminator signals being input into the exclusive-OR gate and the exclusive-OR gate outputting an actuation signal when only one of the first and second discriminator signals indicates an intrusion.

8. A method for detecting an intrusion into a predetermined area, the method inkling the steps of:
orienting a first receiver at a first location within the predetermined area;
orienting a second receiver at a second location within the predetermined area, the second location being different from the first location;
transmitting a signal within the predetermined area;
receiving reflected return signals of the transmitted signal at the first receiver;
receiving reflected return signals of the transmitted signal at the second receiver;
determining whether the reflected return signals received at the first receiver indicate an intrusion or a non-intrusion event;
determining whether the reflected return signals received at the second receiver indicate an intrusion or a non-intrusion event; and
providing an alarm signal if the reflected return signals at only one of the first and second receivers indicate an intrusion.

9. The method as defined in claim 8 further including the steps of:
processing the reflected return signals received by the first receiver to form a first waveform envelope; and
processing the reflected return signals received by the second receiver to form a second waveform envelope.

10. The method as defined in claim 9 wherein the step of determining whether the reflected return signals received at the first receiver indicate an intrusion or a non-intrusion event further includes the steps of:
monitoring the first waveform envelope during time windows; and
discriminating between an intrusion and a non-intrusion event in response to the monitored first waveform envelope during the time windows.

11. The method as defined in claim 10 determining whether the reflected return signals received at the second receiver indicate an intrusion or a non-intrusion event further includes the steps of:
monitoring the second waveform envelope during time windows; and
discriminating between an intrusion and a non-intrusion event in response to the monitored second waveform envelope during the time windows.

12. The method as defined in claim 11 wherein the steps of discriminating between an intrusion and a non-intrusion event in response to the monitored first and second waveform envelopes include the steps of:
(a) determining a non-intrusion event when a value of the respective waveform envelope during a first predetermined time window is less than a first predetermined threshold,
(b) determining an intrusion event when a predetermined number of samples of the respective waveform envelope during a second predetermined time window is greater than a second predetermined threshold, and
(c) determining a non-intrusion event when the predetermined number of samples of the respective waveform envelope during the second predetermined time window is less than the second predetermined threshold.
